(19) United States
(12) Patent Application Publication
(10) Pub. No.: US 2026/0328709 A1
(43) Pub. Date: Oct. 22, 2026

(54) X-RAY DEVICE WITH INFEED TUNNEL FORMED BY PRIMARY AND SECONDARY SHIELDING

(71) Applicant: Lumafield, Inc., Cambridge, MA (US)

(72) Inventors: Shail Rajesh Shah, Cambridge, MA (US); Samuel Dejia Sun, Somerville, MA (US); Steven Thomas, Somerville, MA (US); Simon Edward Kozin, Lexington, MA (US); Kevin David Cedrone, Boxborough, MA (US); Robert Overing, Boston, MA (US); Andrew John Caunter, Cambridge, MA (US)

(21) Appl. No.: 19/650,528

(22) Filed: Apr. 17, 2026

Related U.S. Application Data
(60) Provisional application No. 63/791,099, filed on Apr. 18, 2025.

(51) Int. Cl. G01N 23/046; G21F 7/06

(52) U.S. Cl. CPC G01N 23/046; G21F 7/063; G01N 2223/1016; G01N 2223/643

(57) ABSTRACT

Provided herein are X-ray devices with an infeed tunnel formed by primary and secondary shielding. One device can include an X-ray source configured to emit X-rays; a detector configured and arranged to obtain X-ray scan data for objects; a primary shielding forming a scan chamber, wherein the X-ray source and the detector are located inside the scan chamber, and the scan chamber has an opening into the scan chamber; a secondary shielding outside of the primary shielding and forming with the primary shielding a tunnel having bends to attenuate any X-rays that leave the scan chamber through the opening into the tunnel; and a conveyor system configured and arranged to move the objects through the tunnel to the scan chamber.

### CROSS-REFERENCE TO RELATED APPLICATIONS

This patent application claims priority to and the benefit of U.S. Provisional Patent Application No. 63/791,099, filed on Apr. 18, 2025, which is incorporated herein by reference in its entirety.

### TECHNICAL FIELD

This specificationrelates to X-ray devices, such as computed tomography (CT) devices.

### BACKGROUND

X-ray devices can be used to detect defect(s) in and/or damage to an object (e.g., a manufactured part) without disassembling the object. For example, an X-ray CT scanner can be used by manufacturers to determine the quality of the products which they produce. X-ray devices are particularly useful to give manufacturers the ability to inspect certain parts of their products in a non-invasive, non-destructive fashion. Given this, X-ray devices are becoming more popular in production manufacturing settings where quality control is of high importance.

### SUMMARY

In automated X-ray computed tomography (CT) for inline and/or line-adjacent quality inspection, a product is scanned by an X-ray device (also referred to as an X-ray CT scanner) and categorized as either passing or failing against a set of user-defined quality metrics, for example, proper assembly, size of voids, dimensional errors. In some implementations, to operate the product inspection in an automated manner, the X-ray device can be equipped with a mechanism to exchange an object that has already undergone scanning with another one (e.g., part exchange). In some implementations, this exchange mechanism also rotates the object within the scan chamber during a scan of the object.

In some implementations, e.g., in cone-beam X-ray CT scanners, the X-ray source and detector can be fully enclosed within a shielded enclosure (e.g., a shielded box). The shielding attenuates X-ray radiation to safe levels outside the enclosure. In some cases, the inside of the scan chamber of an X-ray CT scanner can be accessed via a door (which is readily openable by a user) and/or a portal (which requires an access key to open) on the enclosure. In some implementations, the mechanism that handles object exchange (and optionally rotation during object scanning) extends through an opening made when the door is opened.

In some implementations, rather than using a fully enclosed and shielded scan chamber, the scan chamber has an opening that stays open during a scan, and secondary shielding is used to contain X-rays that escape the scan chamber. This enables the free inflow and outflow of objects (e.g., parts to be scanned) to and from the scan chamber. Thus, by not requiring a door into the scan chamber of the X-ray device, where this door must be opened once a scan is completed before a part exchange takes place, the speed and/or throughput of object scanning can be increased. Moreover, the reliability and life span of the X-ray device can be improved as a result of not needing to halt X-ray generation when the door is opened, e.g., cyclically halt and resume X-ray generation when the door is opened and closed.

This specification describes technologies relating to X-ray devices for part exchange and X-ray shielding inside the X-ray devices that enable fast and parallelized part conveyance with scanning. The X-ray devices according to some implementations require no additional actuators beyond those that are used to locate the part within the scan chamber of the X-ray device.

For example, an X-ray device can include an X-ray source, a detector, a shielding, a conveyor system, and a single motion system. The X-ray source is configured to emit X-rays in a scan envelope within a scan chamber. The detector is configured and arranged to obtain X-ray scan data for objects. The shielding forms the scan chamber containing the scan envelope, where the X-ray source and the detector are located inside the scan chamber, and the scan chamber has an opening into the scan chamber, e.g., allowing a scan object to enter or exit the scan chamber. The conveyor system is configured and arranged to move the objects to the scan chamber and away from the scan chamber. The single motion system is configured and arranged to retrieve the objects from the conveyor system, move the objects into the scan envelope within the scan chamber, and return the objects to the conveyor system. The single motion system can include a three-axis gantry that includes a gripper and a linear stage providing an axis of motion that extends through the opening in the scan chamber, where the gripper is configured to grasp, hold, and release the objects.

As another example, an X-ray device can include an X-ray source, a detector, a primary shielding, a secondary shielding, and a conveyor system. The X-ray source is configured to emit X-rays in a scan envelope within a scan chamber. The detector is configured and arranged to obtain X-ray scan data for objects. The primary shielding forms the scan chamber, where the X-ray source and the detector are located inside the scan chamber, and the scan chamber has an opening into the scan chamber. The secondary shielding is outside of the primary shielding and forms with the primary shielding a tunnel having bends to attenuate any X-rays that leave the scan chamber through the opening into the tunnel. The conveyor system is configured and arranged to move the objects through the tunnel to the scan chamber.

Various embodiments of the subject matter described in this specification can be implemented to realize one or more of the following advantages. In some implementations, the X-ray device can leverage the same, single motion system (e.g., a gantry) to perform operations of locating a part within the scan chamber and executing part exchange for an upcoming part to be scanned, yielding significant cost savings for the X-ray device and reduction in complexity, which can improve reliability and reduce maintenance costs. In some implementations, the X-ray device can include one or more tunnels formed between an inner primary shielding and an outer secondary shielding to enable faster cycle times, because part inflow and outflow can occur in parallel with scanning. Parts can be parked at the pick-up location awaiting scan completion and then be ready for delivery into the scan chamber as soon as the just scanned part leaves the scan chamber. In some implementations, the single motion system in the X-ray device (handling both part exchange and part positioning during a scan of that part) can be used in combination with the tunnel formed between the inner primary shielding and the outer secondary shielding of the X-ray device.

In some implementations, part exchange occurs outside the scan chamber, providing improved flexibility. Further, an object can be scanned in multiple positions within the scan chamber. In some cases, a small region of an object may be scanned at high magnification (e.g., closer to the X-ray source) followed by a full-sized scan of the object at low magnification (e.g., closer to the detector). In some implementations, the inner primary shielding and the outer secondary shielding allow the X-ray source to be maintained in a powered state, thereby yielding quality and reliability benefits, because repeated powering up and down an X-ray source causes thermal cycling that may impact the X-ray source life span. The source spot (where the X-rays originate from) may shift until the temperature stabilizes, thereby impacting scan quality, so operating the X-ray source continuously (and thus always at the same stable temperature) can increase the time available for high quality scanning by the X-ray device.

In some implementations, on three of the six walls of the enclosure of the X-ray device, there are two shielded walls (e.g., an inner primary shielding and an outer secondary shielding) separating the scan chamber from the outside environment. This redundancy helps ensure that X-ray emissions that might escape between seams, fastener holes and/or an opening (for object exchange) in the inner primary shielding are attenuated by the outer secondary shielding. In some implementations, the inner primary shielding serves as the inner wall of the shielded tunnel, reducing the total amount of X-ray shielding material (e.g., lead, which is very dense) that is needed. Efficient arrangement of the shielding (e.g., lead) walls in this manner provides space and weight savings.

In some implementations, by including a third shielding to reduce X-ray backscatter from exiting an infeed or an outfeed of the X-ray device, the systems and techniques can improve scan throughput by operating the X-ray device at high power while still attenuating the X-rays to safe levels outside the enclosure. In some implementations, rather than using a tighter collimation, which can be challenging due to the tight tolerances required to significantly collimate the beam without cutting off portions of the detector from the X-ray beam, the detector shielding approach can reduce X-ray emissions without compromising active detector area. In some implementations, rather than increasing the tunnel length or adding bulk shielding to the outer enclosure, the systems and techniques can target a dominant source of the elevated X-ray emissions, e.g., X-ray backscatter from the detector region to effectively reduce the elevated X-ray emissions. By using the detector shielding that is integrated into the detector mounting structure within the scan chamber, the systems and techniques can effectively reduce the X-ray backscatter and improve radiograph quality, without changing the scanner footprint, tunnel geometry, or part conveyance path.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A shows a top-down and schematic view of an example of an X-ray device.

FIG. 1B shows an example of the 3-axis gantry shown in FIG. 1A.

FIG. 1C shows an example of components in FIG. 1B for picking up or dropping off at least one object.

FIG. 1D shows an example of a part carrier configured to carry at least one part / product.

FIG. 1E shows a top-down view of the part carrier from FIG. 1D with an example of fastener points on the part carrier, which are configured and arranged to receive fasteners of a fixturing device used to carry at least one part / product.

FIG. 2A shows a cross-sectional and schematic view of an example of a portion of the X-ray device of FIG. 1A.

FIG. 2B shows a cross-sectional and schematic view of a second example of a portion of an X-ray device.

FIG. 2C shows a cross-sectional and schematic view of another example of a portion of an X-ray device.

FIGS. 3A-3D show an example of a process for object exchange and scanning of objects using an X-ray device according to various implementations.

FIG. 4A shows an example of an X-ray device having a single pick-up and drop-off location for an object.

FIG. 4B shows a second example of an X-ray device having a single pick-up and drop-off location for an object.

FIG. 5 shows an example of an X-ray device having two openings into a scan chamber.

FIG. 6A shows an isometric view of an example of an X-ray device for scanning objects.

FIG. 6B shows a top-down view of a horizontal A-A cross-section of the X-ray device in FIG. 6A.

FIG. 7 shows an example of an X-ray device that has primary and secondary shieldings, as shown in FIG. 6B.

FIG. 8 shows an example of an X-ray device that has a passive (gravity) outfeed.

FIG. 9 shows an example of an X-ray device that has four tunnel bends.

FIG. 10 shows an example of an X-ray device that has the first portion and the second portion of a conveyor system overlapping each other.

FIG. 11 shows an example X-ray device that has additional bends in a tunnel created by additional segments of the secondary shielding.

FIG. 12 shows an example of an X-ray device having a third shielding.

FIG. 13A shows an example of a detector having a mounting structure.

FIG. 13B shows an example of a third shielding placed on two sides of a mounting structure for a detector.

FIG. 13C shows an example of a third shielding placed on three sides of a mounting structure for a detector.

Like reference numbers and designations in the various drawings indicate like elements.

### DETAILED DESCRIPTION

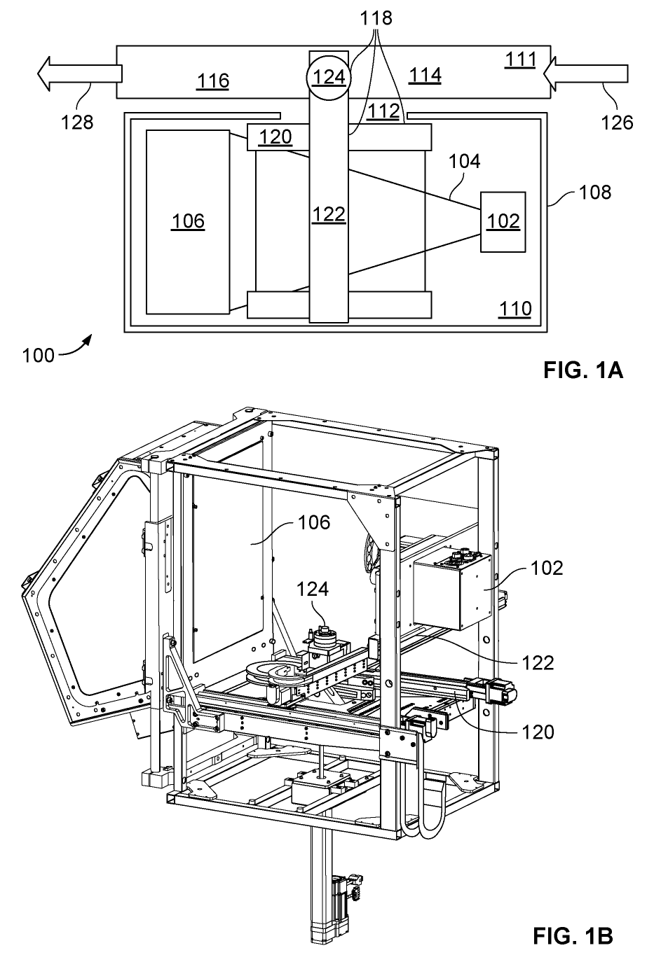

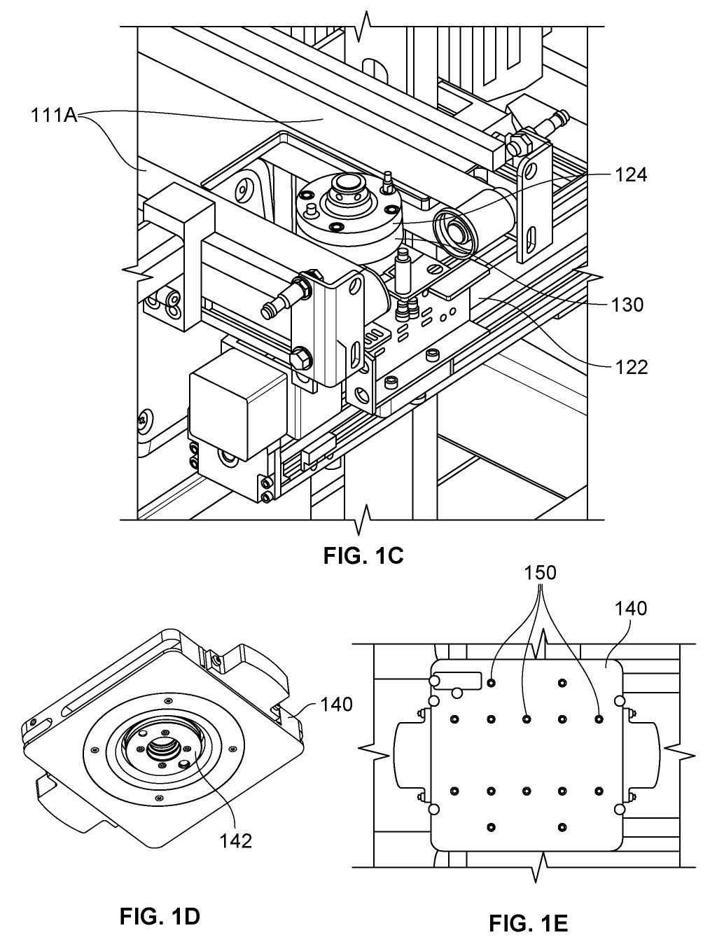

FIG. 1A shows a top-down and schematic view of an example of an X-ray device 100. The X-ray device 100 includes an X-ray source 102 configured to emit X-rays in a scan envelope 104 (e.g., an X-ray cone-beam or a source cone) towards at least one detector 106. For example, the X-ray source 102 can be a 180 kV, 190 kV, or 200 kV source. In some implementations, the X-ray source 102 can be a stationary X-ray source that is at a fixed location and does not move during use. The detector 106 obtains scan data of at least one object (e.g., an object positioned on gripper 124) that passes through the X-ray device 100 (e.g., along a linear stage 122 that is also referred to as the Y-axis in FIG. 1A). The object to be scanned can be the part / product itself, the part / product residing on a carriage, the part / product held in a fixturing device, or the part / product held in a fixturing device that resides on a carriage.

The X-ray device 100 can acquire a set of projections using the detector 106. These projections encode both the energy and quantity of X-ray photons that the detector detects. The X-ray light, which is emitted from the X-ray source 102, can contain distinct energies that are subsequently attenuated by any matter (e.g., the object) between the X-ray source and the detector. The difference in X-ray intensity emitted by the X-ray source and captured by the detector provides information, e.g., densities, about the materials within the path of the X-ray photons.

The detector 106 can be configured and arranged to detect at least one X-ray signal and/or obtain X-ray scan data for the at least one object. In some implementations, the detector 106 refers to a detector assembly that includes a scintillator and a camera. The scintillator is configured to absorb the X-rays that pass through the object and emit light. The camera is configured to detect the light and generate an image using the detected light.

In some implementations, the detector 106 can include any suitable combination of a complementary metal–oxide–semiconductor (CMOS) digital camera sensor, a red-green-green-blue (RGGB) Bayer filter, an optical camera, a monochromatic optical camera, a back-side-illuminated sensor, a front-side-illuminated sensor, a charge-coupled device (CCD) detector, a photodiode, an X-ray flat panel detector, and a linear X-ray detector. The scan data acquired from the detector 106 can be referred to as a projection, or radiograph, which represents the raw scan data from the detector.

In some implementations, the X-ray device 100 can include a shielding 108 that forms a scan chamber 110 containing the scan envelope 104, where the X-ray source 102 and the detector 106 are located inside the scan chamber 110, and the scan chamber 110 has one or more openings (e.g., an opening 112) into the scan chamber 110. The shielding 108 is used to prevent X-rays from leaving the scan chamber 110, including X-rays that are radiated directly from the X-ray source 102 in the scan envelope 104 and/or X-rays scattered from the X-ray source 102 or from other items inside the scan chamber 110, such that the X-ray energies leaving the scan chamber 110 are reduced or eliminated by the shielding 108.

In some implementations, the X-ray device 100 can include a conveyor system 111 configured and arranged to move the at least one object (e.g., from object infeed 126) to the scan chamber 110 (e.g., for scanning of the at least one object) and away from the scan chamber 110 (e.g., after the at least one object is scanned) to object outfeed 128.

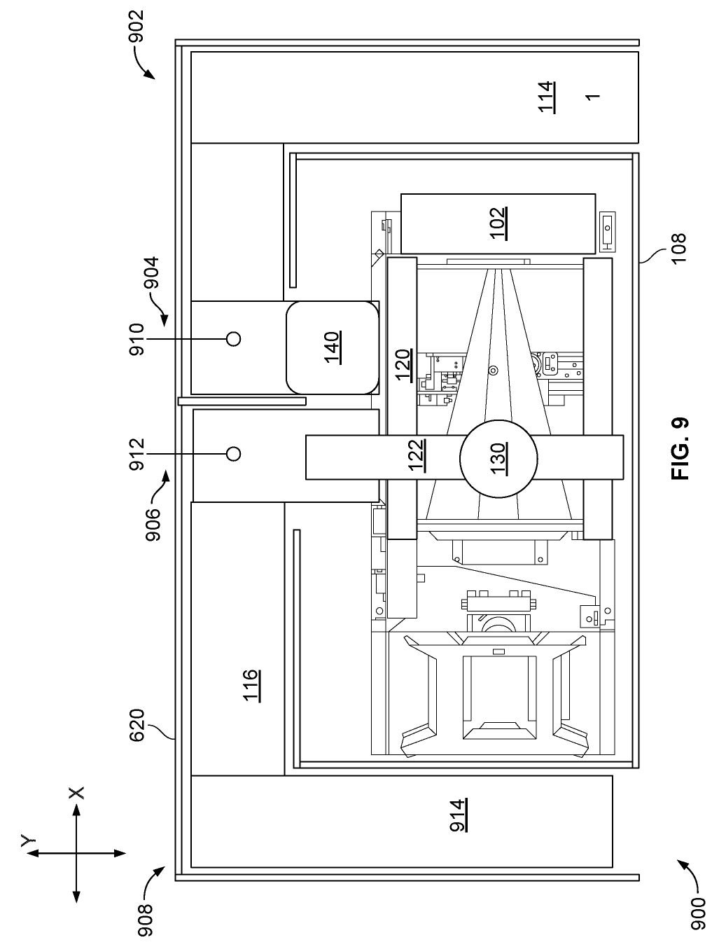

In some implementations, the X-ray device 100 can include a single motion system 118 configured and arranged to retrieve the at least one object from the conveyor system 111, move at least a part of the at least one object into the scan envelope 104 within the scan chamber 110, and return the at least one object to the conveyor system 111. In some implementations, the single motion system 118 can include a three-axis gantry that includes a gripper 124 and a linear stage 122 providing an axis of motion (e.g., the Y-axis in FIG. 1A) that extends to pick-up and drop-off location(s) of the at least one object. For example, if the pick-up and drop-off location(s) is/are located outside the scan chamber 110, the axis of motion can extend through the opening 112 of the scan chamber 110 and to the pick-up and drop-off location(s) of the at least one object, as shown in FIG. 1A. If the pick-up and drop-off location(s) is/are located inside the scan chamber 110, the axis of motion can extend to the pick-up and drop-off location(s) of the at least one object, as shown in FIG. 9.

The extension of the axis of motion to the pick-up and drop-off location(s) can enable the use of a single motion system (e.g., the single motion system 118) for positioning and scanning of the at least one object, thereby saving costs associated with scanning the at least one object and/or increasing scanning throughput. In some implementations, the linear stage 122 can move on a second linear stage 120 along the X-axis in FIG. 1A, such that the at least one object can be moved from the pick-up location on a first portion 114 of the conveyor system 111, into the scan chamber 110 for scanning, and back to the drop-off location on a second portion 116 of conveyor system 111.

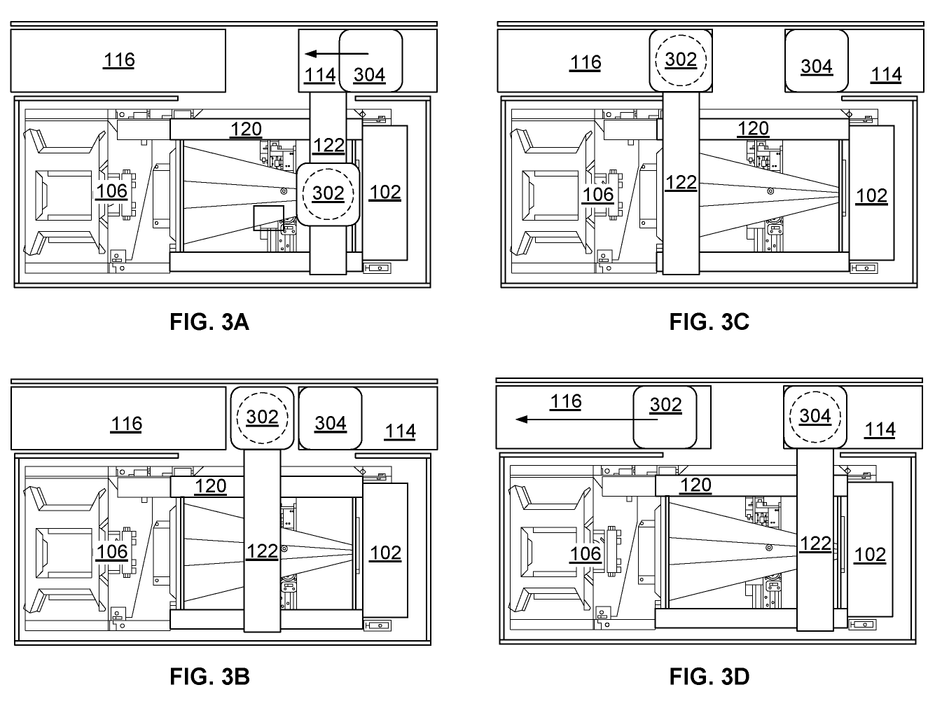

In some implementations, the second linear stage 120 along the X-axis can terminate at the detector 106 (as shown in FIGS. 1B, 5, 6B, and 13B). In some implementations, the second linear stage 120 along the X-axis can extend past the detector 106 (as shown in FIGS. 3A-4B and 7-12). In some implementations, the second linear stage 120 along the X-axis can terminate at some distance away from the detector 106 (as shown in FIG. 1A).

Note that the first portion 114 of the conveyor system 111 can overlap with the second portion 116 of the conveyor system 111, e.g., when the pick-up and drop off locations are the same location. Alternatively, the first portion 114 and the second portion 116 need not overlap and can be separate and distinct portions of the conveyor system 111, e.g., the conveyor system 111 can include two separate conveyor belts that have a space between them, even in the case where there is a single pick-up and drop off location between the two conveyor belts.

In some implementations, the gripper 124 is configured to grasp the at least one object (e.g., from the conveyor system 111), hold the at least one object (e.g., when the at least one object is being scanned in the scan chamber 110), and release the at least one object (e.g., back to the conveyor system 111 after the at least one object has been scanned).

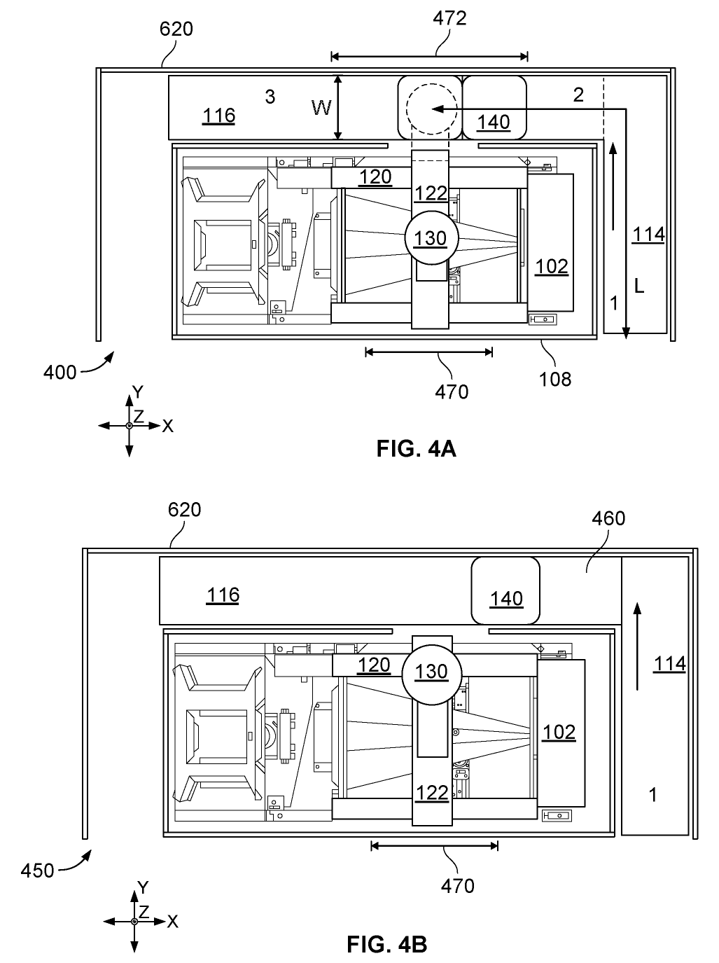

In some implementations, the single motion system 118 can include a motion system other than a three-axis gantry, for example, a robotic arm or one or more pneumatic cylinders. In general, the single motion system 118 should be able to locate the position of the at least one object in a minimum of 2 axes. In implementations with different pick-up and drop-off locations, and when each scan will be at the same elevation, a minimum of two axes are needed, i.e., the Y-axis linear stage and the X-axis linear stage are used together to pick up the part from a first location, bring it to the scan chamber for the scan, and then drop the part off at a second location. In implementations having different pick-up and drop-off locations, and in which scans will occur at different elevations, a minimum of three axes are needed, i.e., a Z-axis stage (such as the Z-axis in/out of page in FIG. 4A) is used to provide the different elevations during scanning).

Nonetheless, in implementations with a single pick-up and drop-off location, and when each scan will be at the same magnification, a minimum of one axis is needed, i.e., the Y-axis linear stage is used to pick up the part, bring it to the scan chamber for the scan, and then drop it back off at the same location. In implementations having a single pick-up and drop-off location and in which scans will occur at different elevations and magnifications, an additional two axes (X and Z) are needed: X for magnification and Z for elevation. In implementations having a single pick-up and drop-off location and in which scans will occur at different elevations OR magnifications, only one additional axis is needed (X or Z).

FIG. 1B shows an example of a 3-axis gantry, which can be used in the X-ray device of FIG. 1A. Various components of the 3-axis gantry, for example, linear stages 120 and 122 and gripper 124, are shown in FIG. 1B, with respect to X-ray source 102 and detector 106. The third axis linear stage can be along the vertical rails on which the linear stages 120 and 122 ride (as shown). In some implementations, a third axis linear stage is included between the linear stage 122 and the gripper 124.

FIG. 1C shows an example of components in FIG. 1A used to pick up and/or drop off the at least one object. One component is the gripper 124 with an integrated rotary stage 130 (on top of the linear stage 122) that is configured to rotate the at least one object using the gripper 124 mounted on the linear stage 122. In some implementations, the rotary stage 130 traverses along the Y-axis shown in FIG. 1A when moving each object into the scan chamber, and then the rotary stage 130 reorients the object (in angular steps or by continuous rotation) when the object is being scanned in scan chamber 110.

In some implementations, the conveyor system 111 is a split-belt conveyor system. When the linear stage 122 is used to retrieve the at least one object from the pick-up location on the first portion 114 of the conveyor system 111 or release the at least one object to the drop-off location on the second portion 116 of the conveyor system 111, the rotary stage 130 plus gripper 124 mounted on the linear stage 122 are positioned in an opening between two split belts 111A of the split-belt conveyor system, at the pick-up location and/or at the drop-off location. In some implementations, the gripper 124 can rise from below the split-belt conveyor system and through the opening between the two split belts 111A of the split-belt conveyor system at the pick-up and/or drop-off location(s).

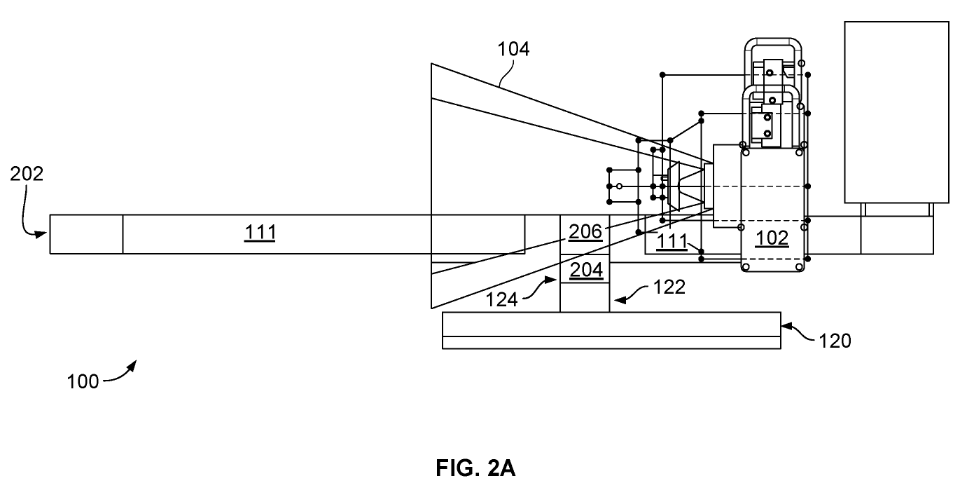

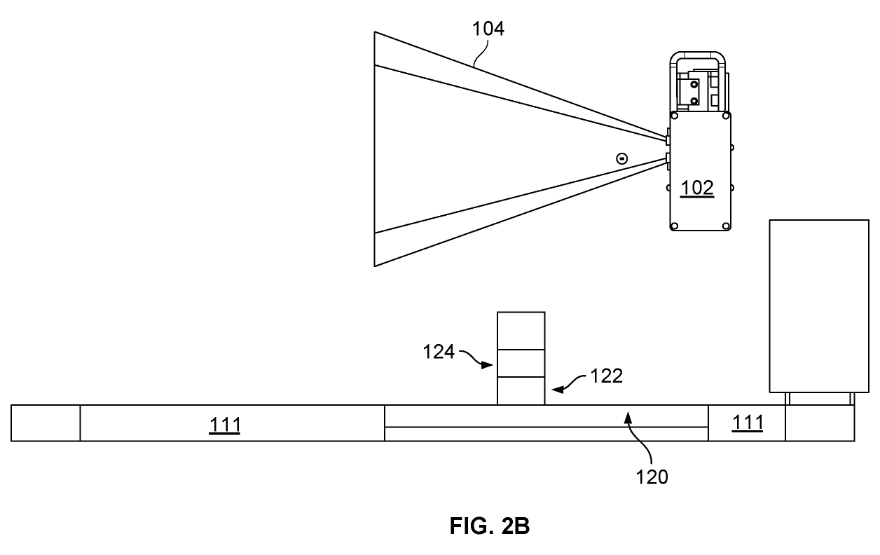

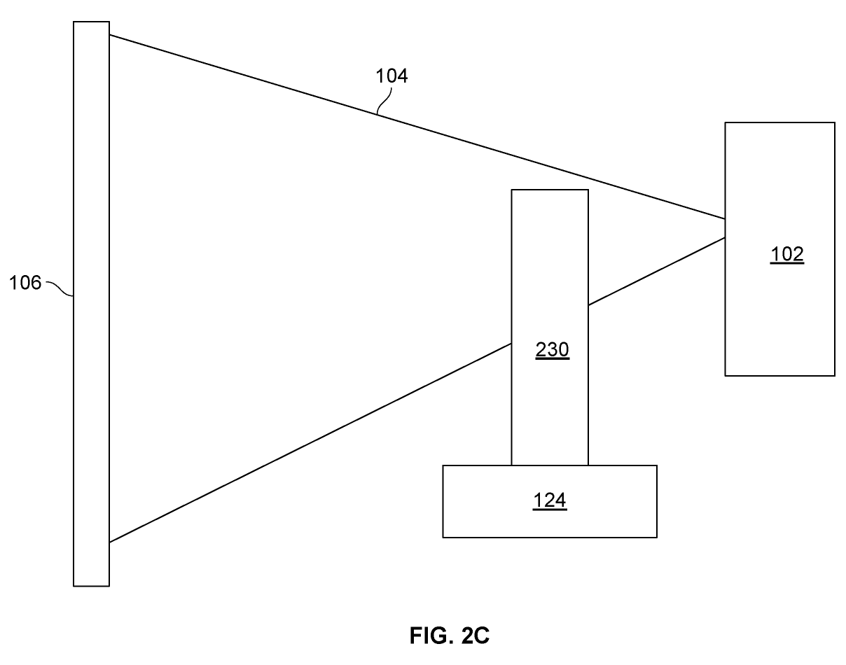

FIG. 1D shows an example of a part carrier 140 configured to carry the objects to be scanned. The part carrier 140 can also be referred to as a carriage or a puck. In some implementations, the part carrier 140 can be a puck that has a dimension of 150 mm, 200 mm, or 250 mm. The underside of the part carrier 140 includes a gripper interface 142. The gripper 124 is configured to grasp the part carrier 140 through the gripper interface 142, such that the gripper 124 can control the motion (e.g., rotation and/or translation) of the carried on the part carrier 140. In some implementations, each of the objects to be scanned can include a component that can be removably attached to the part carrier 140 (e.g., on the opposite side of the gripper interface 142). In some implementations, the gripper 124 is configured to grasp the at least one object directly, without using an intermediate part carrier such as the part carrier 140. An example of this implementation is shown in FIG. 2C described below.

FIG. 1E shows example fastener points 150 on the part carrier 140 of FIG. 1D that are configured to carry the object to be scanned. In some implementations, the aforementioned component that can be removably attached to the part carrier 140 is a part (e.g., a manufactured part to be scanned in the scan chamber 110) in a fixturing device (e.g., a fixturing device made by the manufacturer of the part and used to hold the manufactured part), and the part carrier 140 includes fastener points 150 that are configured and arranged to receive fasteners of the fixturing device. In some implementations, an object is the manufactured part to be scanned itself, the manufactured part on the part carrier 140, or a component (e.g., the manufactured part and the fixturing device holding the manufactured part) on the part carrier 140.

FIG. 2A shows a cross-sectional and schematic view of an example of a portion of the X-ray device 100 in FIG. 1A. In some implementations, the conveyor system 111 is a split-belt conveyor system, for example, the split-belt conveyor system shown in FIG. 1C, and a maximum vertical position of the linear stage 122 providing the axis of motion that extends through an opening of the scan chamber 110 is below a lower plane 202 of the split-belt conveyor system, such that the linear stage 122 can travel freely below the split-belt conveyor system. The gripper 124 (with optional integrated rotary stage 130) can thus be brought under the belts of the conveyor system in a first position 204, e.g., positioned in an opening between two split belts of the split-belt conveyor system, lifted up between the split belts into a second position 206, at which point the gripper 124 can grasp the object. Once grasped, the object can be lifted off of the split belts and moved into the scan chamber 110, where the object is then scanned, e.g., as the rotary stage 130 rotates the object inside the scan envelope 104. Further, the object can then be moved back to the conveyor system, positioned between the split belts and lowered onto the split belts. Then, the gripper 124 releases the object, and is free to pick up the next object for scan.

In some implementations, the conveyor can be positioned at the lowest vertical travel of the Y-axis. FIG. 2B shows a cross-sectional and schematic view of a second example of a portion of an X-ray device, according to some implementations. In these implementations, incoming objects (e.g., parts) cannot occupy the part pick-up location as they would obstruct the Y-axis extension of the linear stage 122. Thus, this configuration can result in a speed penalty for the X-ray device operations as compared to that of FIG. 2A.

In some implementations, the single motion system 118 that grips and moves the at least one object can be configured to grip the at least one object from above, with the at least one object hanging below the gripper 124 (e.g., through a part carrier 140 that is coupled to the gripper 124 from below the gripper 124). Further, some implementations do not utilize a part carrier 140, and the gripper 124 directly grasps the part / product. FIG. 2C shows a cross-sectional and schematic view of a third example of a portion of an X-ray device. In some implementations, each of the object can be a manufactured part (e.g., part 230), and the gripper 124 is configured to grasp the part 230 directly, as shown. In some implementations, the part 230 is the product to be scanned plus a fixturing device that the gripper 124 grasps. In some implementations, the part 230 is two or more separately manufactured parts that are fixtured together and scanned as a batch or individually (one after another).

In some implementations, the gripper 124 is made (at least in part) of materials that will not interfere with the scan while holding the part 230 within the scan envelope 104. In some implementations, the material of the gripper does not matter when only a portion of the part 230 needs to be scanned. Thus, the gripper can hold the part 230 at a location that does not need to be scanned, and potentially, the gripper 124 need not even enter the scan envelope 104, as shown in FIG. 2C, while a portion of the part 230 is scanned within the scan envelope 104.

FIGS. 3A-3D illustrate an example process for scanning objects using the X-ray device 100 of FIG. 1A. As shown in FIG. 3A, as the first step of the example process, an object composed of a part carrier 302 (with a part thereon) coupled (e.g., through a gripper 124 previously described) to a linear stage 122 of a single motion system (e.g., the single motion system 118 previously described), is positioned between the X-ray source 102 and the detector 106 using the linear stage 122 (Y-axis) and the linear stage 120 (X-axis), and scanned in the scan chamber 110 by the X-ray source 102, e.g., rotating on the rotary stage 130 in the scan chamber 110. Multiple radiographs of the object (or at least the part on the part carrier 302) can be captured at different rotational angles and optionally at different positions within the scan chamber 110, e.g., closer to or further away from the detector 106. These radiographs can then be used to calculate a 3D reconstruction of the part.

During this scan, another part to be scanned next is moved by a part carrier 304 on the first portion 114 of a conveyor system (e.g., the conveyor system 111 described previously) from an infeed of the X-ray device (e.g., object infeed 126 described previously) towards a pick-up location on the first portion 114 of the conveyor system, such that the other part can be moved to the scan chamber 110 by the linear stage 122 for scanning. In some implementations, when the part is being scanned in scan chamber 110, the part carrier 304 carrying the other object is out of the travel range of the linear stage 122 along the X-axis, such that the part carrier 304 does not interfere with the positioning of the linear stage 122 in the X-axis direction, e.g., the design of the single motion system 118 can have a maximum vertical position of the linear stage 122 (providing the axis of motion that extends through the opening) be below a lower plane of the split-belt conveyor system.

As shown in FIG. 3B, as the second step of the example process, the linear stage 120 (X-axis) and the linear stage 122 (Y-axis) are used to move the part on the part carrier 302 out of the scan envelope 104, through the opening in the scan chamber 110, and to a space between the first portion 114 of the conveyor system and a second portion 116 of the conveyor system. Then, the part exchange can occur.

As shown in FIG. 3C, as the third step of the example process, the linear stage 122 moves the part carrier 302 (with the just scanned part thereon) to the drop-off location on the second portion 116 of the conveyor system, and drops off the object that has been scanned onto the second portion 116 of the conveyor system (e.g., by placing the part carrier 302 carrying the part that has been scanned back on the second portion 116 of the conveyor system). In some implementations, the part carrier 304 moves towards the pick-up location of the other part to be scanned while linear stage 122 carrying the part that has been scanned moves along the linear stage 120 (e.g., in X-axis direction described previously) to the drop-off location of the object that has been scanned. Thus, the incoming parts to be scanned cannot interfere with the actions of the single motion system, either during the scan of the current part or during the drop off of the now scanned part.

Once the part carrier 302 is released on the second portion 116 of the conveyor system, the linear stage 122 can move along the linear stage 120 (X-axis motion) to pick up the part carrier 304 from the pick-up location. As shown in FIG. 3D, as the fourth step of the example process, the linear stage 122 can move along the linear stage 120 (e.g., in X-axis direction described previously) to the pick-up location of the other part to be scanned, and pick up the part carrier 304 that carries the other part to be scanned from the first portion 114 of the conveyor system (e.g., by lifting up the part carrier 304 off the first portion 114 of the conveyor system after the gripper 124 has grasped the part carrier 304), and subsequently move the part carrier 304 carrying the other part along the X-axis (back to the gap separating the pick-up and drop-off locations on first portion 114 and second portion 116 of the conveyor system) and then along the Y-axis into the scan chamber 110 for scanning of the other part (e.g., for rotation by the rotary stage 130 during the scan). This next scan proceeds while part that has been scanned is conveyed by the part carrier 302 on the second portion 116 of the conveyor system away from the scan chamber 110 and to an outfeed (e.g., the object outfeed 128 described previously). Thus, the X-ray device 100 can leverage the same motion system 118 (e.g., a 3-axis gantry) to perform operations of locating a part within the scan chamber 110 and executing part exchange for upcoming part to be scanned, yielding significant cost savings and reductions in complexity, which can improve reliability and reduce maintenance costs. Moreover, the inflow of new parts for scanning, the scanning of a current part, and the outflow of already scanned part can all occur concurrently with none of these three activities interfering with another, thus improving the speed and/or throughput of object scanning process using the X-ray device.

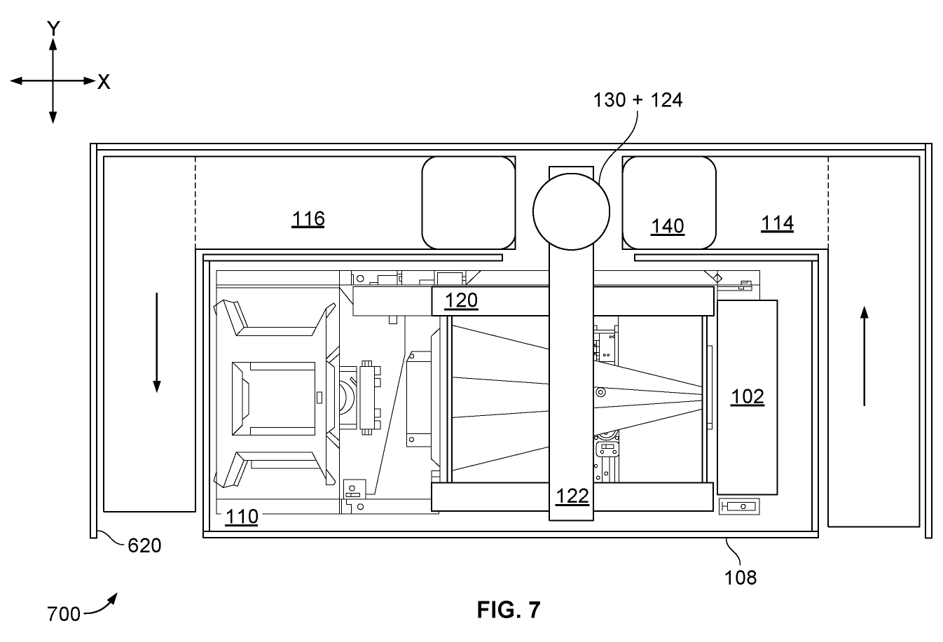

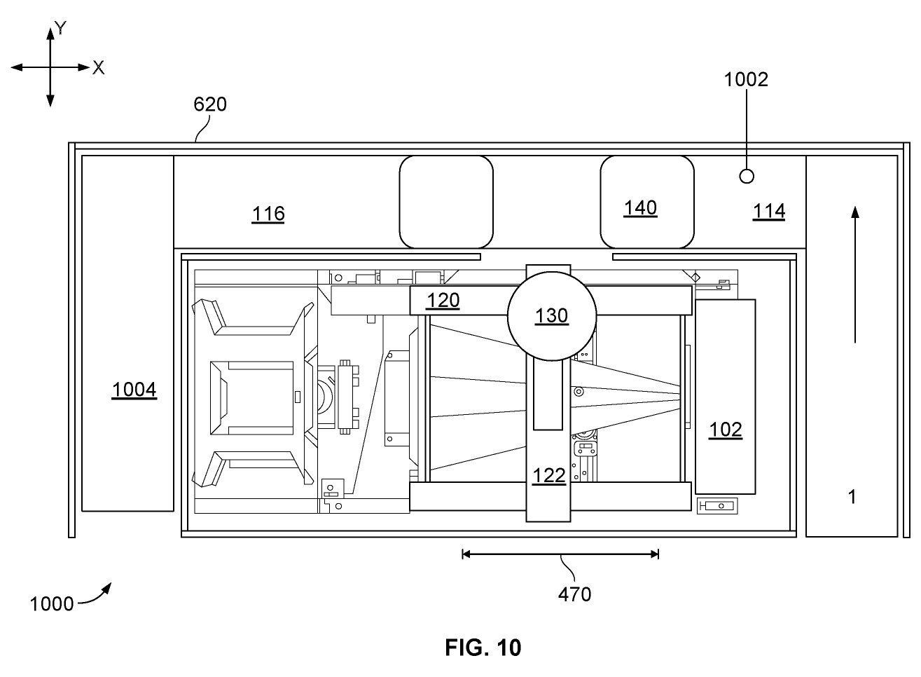

The examples of FIGS. 3A-3D have a space between the pick-up and drop-off locations, but this is not required in all implementations. In some implementations, the pick-up location of the other part to be scanned and the drop-off location of the part that has been scanned can be the same location (e.g., as shown in FIGS. 4A, 4B, or 8). In some implementations, the pick-up location of the other part to be scanned can be separated from the drop-off location of the part that has been scanned in a different manner (e.g., as shown in FIG. 9, and note that some implementations do not include a single motion system with an axis of motion that extends through an opening in the scan chamber, as shown in FIG. 9). In some implementations, the first and second portions 114 and 116 of the conveyor system can overlap with each other (e.g., as shown in FIG. 10), or have a break between the conveyor belt of the first portion 114 and the conveyor belt of the second portion 116 (e.g., as shown in FIG. 7).

As will be appreciated, the embodiments described in connection with FIGS. 1A-3D (without shielding tunnels having bends therein) can be implemented together with the embodiments described in connection with FIGS. 4A-11 (with shielding tunnels having bends therein). Nonetheless, this is not required. In some embodiments, the shielding tunnels through which the first portion 114 and the second portion 116 of the conveyor system (as shown in FIGS. 3A-3D) can be made long enough that any X-rays that escape the scan chamber will be adequately attenuated and not pose a danger to the surrounding environment. In some cases, only one of the tunnels is made long (e.g., the outfeed tunnel) and a bend is included in the other tunnel (e.g., the infeed tunnel). Nonetheless, at least two bends in the tunnels is generally preferred due to the reduced amount of space needed for the X-ray device.

FIG. 4A shows an example X-ray device 400 having a single pick-up and drop-off location for an object. FIG. 4A is similar to FIG. 3A, except that in FIG. 4A, the pick-up location for an object (e.g., a part on a part carrier 140) to be scanned is the same as the drop-off location for an object that has been scanned, while in FIG. 3A, the pick-up location for an object to be scanned is separated from the drop-off location for an object that has been scanned, as the first portion 114 that includes the pick-up location is separated from the second portion 116 that includes the drop-off location.

In some implementations, to use the single pick-up and drop-off location to pick up an object that is to be scanned and to drop off an object that has been scanned, a process can be performed to (1) hold the incoming object to be scanned away from the single pick-up and drop-off location (e.g., using a blocker mechanism positioned by the first portion 114 of the conveyor system), (2) drop off the object that has been scanned from the linear stage 122 to the single pick-up and drop-off location, (3) release the object that has been scanned from the single pick-up and drop-off location (e.g., to the second portion 116 of the conveyor system, which overlaps with the first portion 114 of the conveyor system in the example of FIG. 4A), (4) pick up the object to be scanned from the single pick-up and drop-off location once there (e.g., after releasing the blocker mechanism, the object will be moved into the single pick-up and drop-off location by the first portion 114 of the conveyor system), and (5) move the object to be scanned into the scan chamber 110 for scanning of the object.

In some implementations, the single pick-up and drop-off location is a space between an infeed conveyor belt and an outfeed conveyor belt, as shown in FIG. 4A. In some implementations, the single pick-up and drop-off location is located on a single conveyor belt that is both part of the infeed portion and the outfeed portion of the conveyor system. FIG. 4B shows a second example X-ray device 450 having a single pick-up and drop-off location for an object. FIG. 4B is similar to FIG. 4A, except that in FIG. 4B, the first portion 114 overlaps with the second portion 116 of the conveyor system on a single conveyor belt, i.e., an unbroken conveyor section 460. In either case, and regardless of how many conveyors are used or whether bends are used for the shielding tunnels formed (in part) by a secondary shielding 620, the X-ray device can include a scanner access hatch 470 (e.g., a sliding door) into the scan chamber formed by shielding 108. In some implementations, the X-ray device can include an exchange access hatch 472 (e.g., a sliding door) into the space formed by the secondary shielding 620, as shown in FIG. 4A.

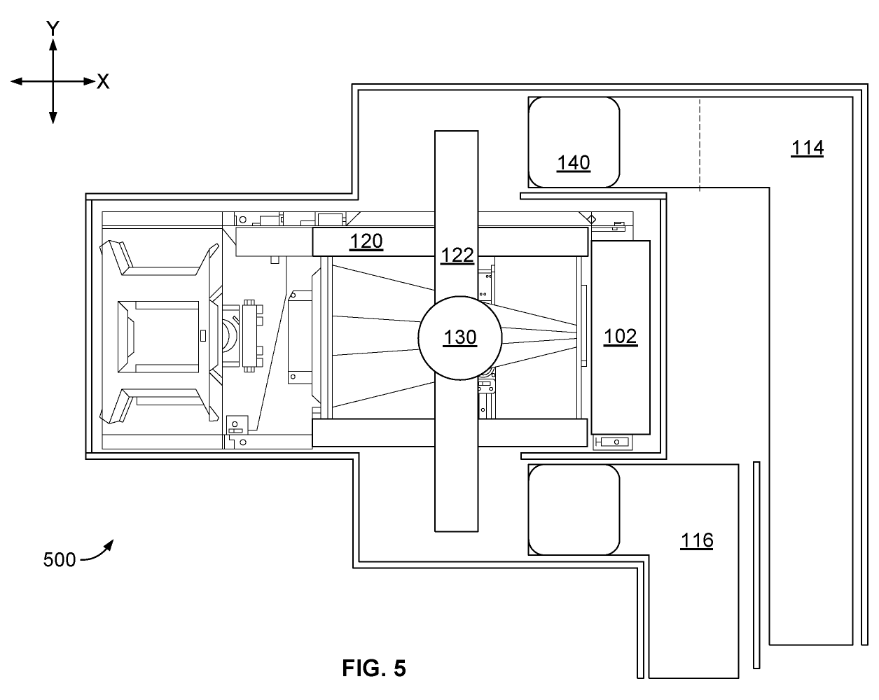

FIG. 5 shows an example of an X-ray device 500 having two openings into a scan chamber. In some implementations, the first opening is the same as opening 112 in FIG. 1A, and the second opening is on the opposite side of the first opening, as shown in FIG. 5. The linear stage 122 provides an axis of motion that extends through both the first opening and the second opening in the scan chamber. The pick-up location of an object to be scanned is on the first portion 114 of a conveyor system, and the linear stage 122 extends through the first opening to the pick-up location. For example, the conveyor system can be a split-belt conveyor system having the first portion 114 and the second portion 116. The drop-off location of an object that has been scanned is on the second portion 116 of the conveyor system, and the linear stage 122 extends through the second opening to the drop-off location. Moreover, shielding can be used to attenuate X-rays that escape through either of the first and second openings, as shown and described.

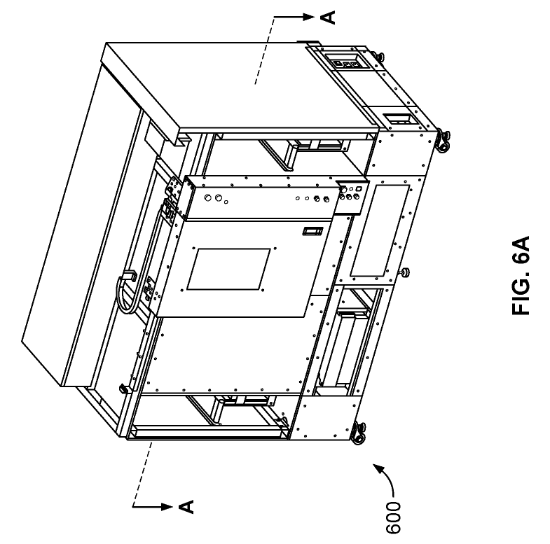

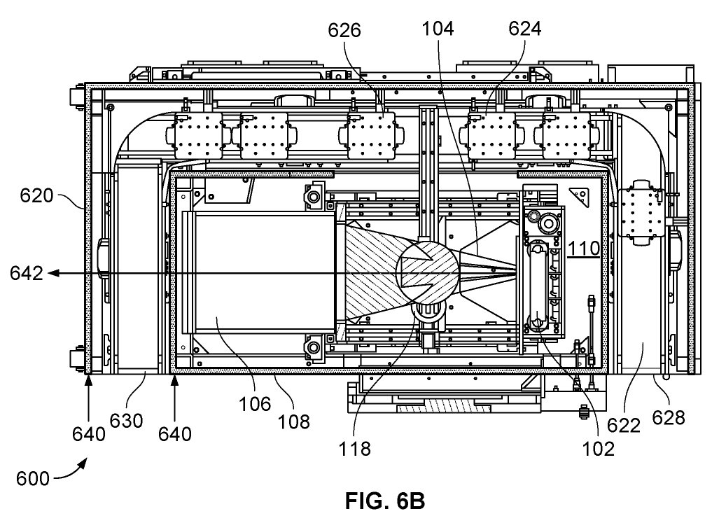

FIG. 6A shows an isometric view of an example X-ray device 600 for scanning objects. In some implementations, the various details described above can be used with the example X-ray devices in FIGS. 6A-11. In some implementations, the various details described next and associated with FIGS. 6A-11 can be used with the example X-ray devices in FIGS. 1A -5.

In some implementations, the example X-ray device 600 in FIG. 6A includes the example X-ray device 100 in FIG. 1, as well as a secondary shielding 620 shown in FIG. 6B and described below. FIG. 6B shows a top-down view of a horizontal A-A cross-section of the example X-ray device 600 from FIG. 6A. The components shown in FIG. 6B are similar to those in FIG. 1A, except that a secondary shielding 620 is shown in FIG. 6B, which forms a tunnel 622 in cooperation with shielding 108 (the primary shielding forming the scan chamber) that includes bends to attenuate X-rays that escape from the scan chamber 110. Additionally, FIG. 6B shows a part entry 628 for receiving at least one object to be scanned in scan chamber 110, where the part entry 628 can be connected to object infeed 126 in FIG. 1A. FIG. 6B also shows a part exit 630 for delivering at least one object that has been scanned in scan chamber 110, where the part exit 630 can be connected to object outfeed 128 in FIG. 1A. Pick-up location 624 of at least one object to be scanned in scan chamber 110 and drop-off location 626 of at least one object that has been scanned in scan chamber 110 are also shown in FIG. 6B. Other components in FIG. 6B, for example, X-ray source 102, detector 106, shielding 108, scan chamber 110, and motion system 118 such as a 3-axis gantry, can be the same as those described previously.

In some implementations, a conveyor system (e.g., conveyor system 111 in FIG. 1A) is configured and arranged to move at least one object to be scanned through the tunnel 622 to the scan chamber 110. In some implementations, the example X-ray device 600 can include a motion system 118 such as the 3-axis gantry, where the motion system is located at least partially inside the scan chamber 110, the motion system is configured and arranged to move the at least one object from the conveyor system through an opening of the scan chamber 110, and into the scan chamber 110. In some implementations, the motion system is configured and arranged to move at least one object both (i) from a first portion (e.g., first portion 114 in FIG. 1A) of the conveyor system into the scan chamber 110 and (ii) from the scan chamber 110 to a second portion (e.g., second portion 116 in FIG. 1A) of the conveyor system.

In some implementations, a motion system other than the 3-axis gantry can be used, e.g., a robotic arm or pneumatic cylinders, provided that the motion system can locate the position of the at least one object in a minimum of 2 axes. Other examples include a 5-bar linkage. In some implementations, the X-ray device 600 does not include a motion system, and a conveyor system in tunnel 622 can move the at least one object into and out of the scan chamber 110. In some implementations, because the X-ray shielding material is dense and heavy (e.g., lead walls between 2-10 mm in thickness), the shielding 108 doubles as the inner wall of the tunnel 622. Efficient arrangement of the lead walls in this manner provides space and weight savings.

In some implementations, the motion system 118 in the X-ray device 600 can pair with the tunnel 622 formed between the shielding 108 (inner primary shielding) and the secondary shielding 620 (outer secondary shielding) to enable faster cycle times, because part inflow and outflow can occur in parallel with scanning. Parts can be parked at the pick-up location awaiting scan completion.

The secondary shielding 620 is outside of the shielding 108 and attenuates any X-rays that leave the scan chamber 110 (e.g., escape from X-ray source 102 or scatter from scan chamber 110). In some implementations, on three of the six walls of the enclosure of the X-ray device 600, there are two shielded walls (e.g., the shielding 108 forming the scan chamber and the secondary shielding 620 forming the tunnel in combination with the shielding 108) separating the scan chamber 110 from the outside environment. This redundancy helps ensure that X-ray emissions that might escape between seams and/or fastener holes in the inner primary shielding 108 are attenuated by the outer secondary shielding 620.

In particular, a double wall 640 of shielding can be provided across an emission path 642 of the X-ray source 102, thus absorbing primary emissions of the X-ray source. In some implementations, the shielding 108 and the secondary shielding 620 allows the X-ray source 102 to be maintained in a powered state, thereby yielding quality and reliability benefits, because repeated powering up and down the X-ray source 102 can cause thermal cycling that may impact the life of the X-ray source 102. The source spot (where the X-rays originate from) may shift until the temperature stabilizes, thereby impacting scan quality, so operating the X-ray source continuously (and thus always at the same stable temperature) can increase the time available for high quality scanning by the X-ray device. Having the double wall 640 of shielding across the emission path 642 (in addition to the bends in the tunnel 622) allows the X-ray source 102 to be maintained in a powered state (without repeated powering up and down) while the part exchange and part scanning is ongoing without closing the opening into the scan chamber 110. Moreover, in some implementations, the opening into the scan chamber 110 includes added lead panels to reduce the size of the opening as much as possible, e.g., the opening in the scan chamber 110 above the plane of the conveyors can be sized to be only large enough to allow the maximum predetermined size object therethrough.

As noted, the tunnel 622 formed between the secondary shielding 620 and the shielding 108 can have one or more bends that attenuate the X-rays that leave the scan chamber 110 (e.g., escape from X-ray source 102 or scatter from scan chamber 110). In some implementations, the tunnel 622 has a first portion and a second portion, where the first portion of the tunnel 622 has at least one of the one or more bends, and the second portion of the tunnel has at least one of the one or more bends. The conveyor system (e.g., conveyor system 111 in FIG. 1A) has a first portion (e.g., first portion 114 in FIG. 1A) and a second portion (e.g., second portion 116 in FIG. 1A). The first portion of the conveyor system is configured and arranged to move the at least one object from an infeed (e.g., object infeed 126 in FIG. 1A) of the X-ray device 600 through the first portion of the tunnel to the scan chamber 110, the second portion of the conveyor system is configured and arranged to move the objects away from the scan chamber 110 through the second portion of the tunnel. In some implementations, the tunnel 622 may not have a bend, when tunnel 622 is long (e.g., relative to the width of tunnel 622), for example, when the tunnel formed between the shielding 108 and the secondary shielding 620 in FIG. 6A is long, as described above. In some implementations, tunnel 622 can have two or more bends to attenuate the X-rays effectively in a reasonable amount of space for the X-ray device 600 of FIG. 6A. In some implementations, each of the bends is a ninety degree bend in the tunnel 622, as shown. In some cases, the bends can have angles other than ninety degrees, such as 120 degrees and/or 135 degrees. In general, the bends can have angles in a range from 80 to 175 degrees.

FIG. 7 shows an example X-ray device 700 that has the two shieldings shown in FIG. 6B. Components in FIG. 7 are similar to those in FIG. 1A, except that a secondary shielding 620 is shown in FIG. 7, and a conveyor system (e.g., the conveyor system 111 in FIG. 1A) between the secondary shielding 620 in FIG. 7 and the shielding 108 is also shown in FIG. 7. Other components shown in FIG. 7, for example, X-ray source 102, shielding 108, scan chamber 110, linear stage 120, linear stage 122, gripper 124 plus rotary stage 130, first portion 114 and second portion 116 of the conveyor system, and part carrier 140 (e.g., a puck), have been described above. For example, the conveyor system can be a split-belt conveyor system having the first portion 114 and the second portion 116. Note that the X-ray device 700 includes four conveyor belt sections, as compared to the two conveyor belt sections of the X-ray device 450, or the three conveyor belt sections of the X-ray device 400.

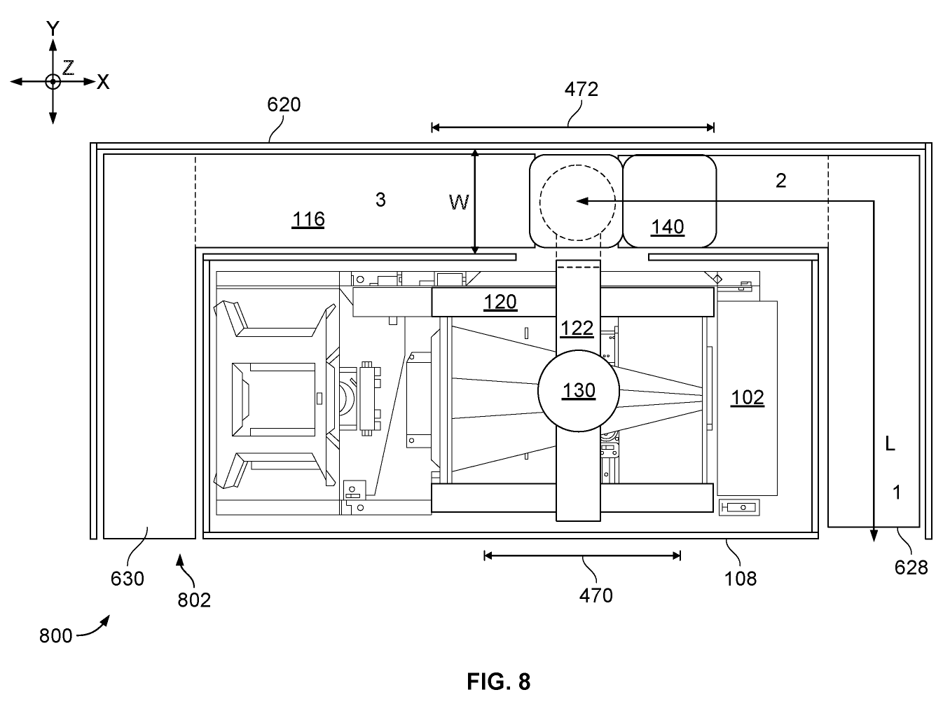

FIG. 8 shows an example X-ray device 800 that has a passive (gravity) outfeed 802, e.g., a ramp. Any of the various implementations described in this application can include such a passive (gravity) outfeed 802, e.g., a ramp, located in the object outfeed portion of the X-ray device, e.g., inside a second portion of the tunnel 622. Thus, the second portion 116 of a conveyor system (e.g., conveyor system 111 in FIG. 1A) can be configured and arranged to move at least one object that has been scanned in the scan chamber 110 away from the scan chamber 110 and to a beginning of a passive (gravity) outfeed, e.g., a ramp.

As described above, having the double wall of shielding across the emission path of the X-ray source, along with the bends in the tunnel for inflow of objects to, and outflow of objects from the scan chamber, allows the X-ray source to remain powered up while the opening into the scan chamber stays open. In some implementations, each of the shielding 108 and the secondary shielding 620 can include lead (e.g., 2-10 mm thick lead) to attenuate X-rays emitted by the X-ray source 102 and/or scattered from the scan chamber 110. In addition, in some implementations, a ratio of a maximum width (e.g., W in FIGS. 8 & 4A) of the tunnel 622 to a length of the tunnel 622 (e.g., L in FIGS. 8 & 4A) has been minimized for a predefined maximum size of the at least one object to be scanned, in view of the X-ray source (energy, flux, and/or X-ray beam geometry) and, optionally a predefined maximum size of the X-ray device, such that X-rays that leave the scan chamber 110 can be attenuated to a predefined level before they can escape from the X-ray device. In other words, the length L is determined (in view of the width W needed to fit therethrough the maximum sized object the X-ray device has been designed for) to ensure that any X-rays leaving the scan chamber 110 encounter several bounces within the tunnel 622 before reaching the outside of the X-ray device 600. Each bounce results in a loss of X-ray energy, leaving residual X-ray emissions at the part entry 628 and part exit 630 within safe limits.

For example, the predefined maximum size can be that the part must fit within a 215 mm x 375 mm cylinder. In general, the predefined maximum size (object size constraint) can be defined in terms of a diameter and a height (e.g., part diameters are allowed to vary from 50 mm to 220 mm, with heights ranging from 50 mm to 400 mm) or in terms of height, width and length ranges. For example, the maximum width can be selected from a range of 150 mm to 300 mm, e.g., 240 mm, the maximum height can be selected from a range of 400 mm to 1200 mm, e.g., 400 mm, and the maximum length can be selected from a range of 1200 mm to 2500 mm, e.g., 1500 mm.

Note that the height of the tunnel also impacts the X-ray attenuation by the tunnel, and the tunnel height needs to accommodate both the part and the conveyor system, e.g., the full tunnel height can be 1000 mm in some implementations, including space below the conveyors. Further, since the motors and wiring below the conveyors can also attenuate the X-rays in some implementations, some testing of a specific implementation design for a specific predefined maximum size of the object may be needed to properly minimize the ratio of width to length of the tunnel. In some implementations, the tunnel geometry (e.g., width or length of the tunnel) can be impacted by the amount of scattered X-rays, which heavily depends on the X-ray energy and flux. In some implementations, the system can set the width of the tunnel based on the dimensions of the parts to be scanned. For example, the system can set the width of the tunnel to be a width that is wide enough to allow the parts through but no wider than necessary. In some implementations, the system can adjust the width of the tunnel by designing the primary shielding and secondary shielding having a predetermined distance away from each other. In some implementations, the system can adjust the width of the tunnel by adding periodic apertures with openings based on the height and/or width of the parts along the length of the tunnel. In some implementations, the system can increase the length of the tunnel by adding additional shielding segment(s) toward the end of the tunnel if, for example, a more powerful X-ray source is used or if the part results in higher scatter condition than expected. Other factors to consider in this minimization process include the X-ray voltage and current, the nature of the parts being scanned, and the geometry of the various components of the X-ray device, e.g., opening size, tunnel geometry, X-ray source position relative to the opening, etc. In any case, this minimized ratio can be applied across all the implementations shown in FIGS. 4A-11, and can also be applied to the implementations described in connection with FIGS. 1A-3D, where the lack of bends in the tunnel will result in a larger length L being needed for adequate X-ray energy attenuation.

FIG. 9 shows an example X-ray device 900 that has at least four bends in its tunnel, along with five conveyor belt sections and a passive (gravity) outfeed 914. For example, compared with the example X-ray device 800 in FIG. 8, the X-ray device 900 includes two additional conveyor sections 910 and 912. The tunnel turns into and out of the opening into the scan chamber 110, forming two openings, as shown in FIG. 9, and the tunnel formed between the shielding 108 and the secondary shielding 620 has four bends. A first portion of the tunnel has two bends (i.e., bends 902 and 904) between an infeed of the X-ray device 900 and the scan chamber 110, and a second portion of the tunnel has two bends (i.e., bends 906 and 908) between the scan chamber 110 and an outfeed of the X-ray device 900. In some implementations, the conveyor system for the X-ray device 900 can be a split-belt conveyor system having the first portion 114 and the second portion 116.

FIG. 10 shows an example X-ray device 1000 that has the first portion 114 and the second portion 116 of the conveyor system overlapping each other. The X-ray device 1000 can include a passive (gravity) outfeed 1004. In some implementations, the first portion 114 and the second portion 116 of the conveyor system form an unbroken or continuous conveyor system along the rear of the X-ray device 1000, as shown. For example, the X-ray device 1000 includes an unbroken conveyor section 1002. Components in FIG. 10 are similar to those in FIG. 7, except that in FIG. 10, the first portion 114 and the second portion 116 of the conveyor system in FIG. 10 overlap each other, whereas in FIG. 7, the first portion 114 and the second portion 116 of the conveyor system are separated from each other.

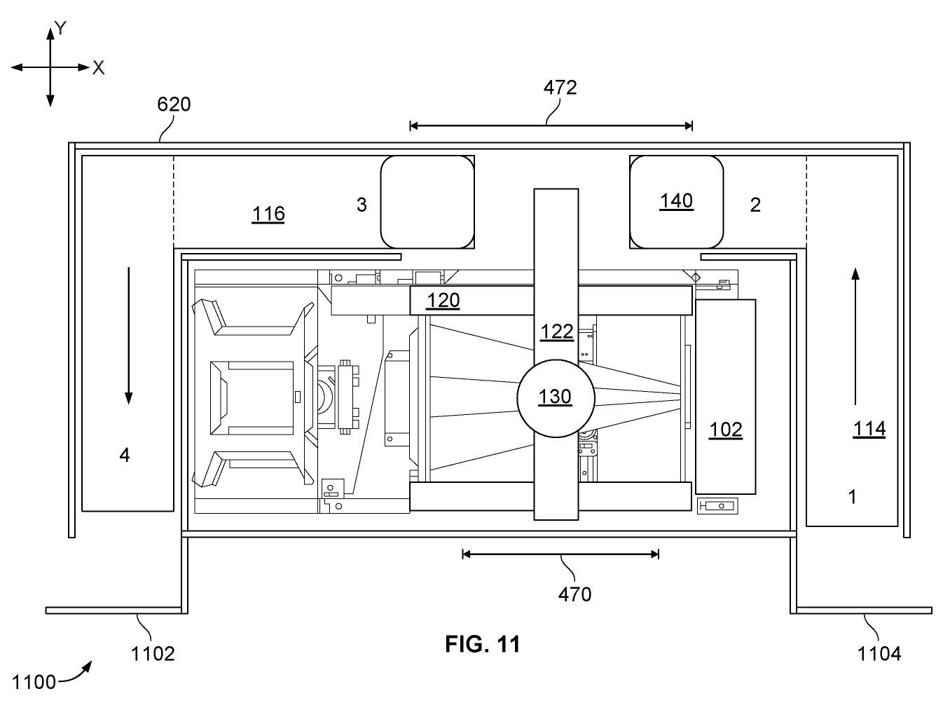

FIG. 11 shows an example X-ray device 1100 that has additional bends of the tunnel created by additional secondary shielding segments. Components in FIG. 11 are similar to those in FIG. 7, except that two additional segments 1102 and 1104 have been added to secondary shielding 620 to create two additional bends of the tunnel between the primary and the secondary shieldings, when compared to the bends in FIG. 7. In some implementations, the conveyor system for the X-ray device 1100 can be a split-belt conveyor system having the first portion 114 and the second portion 116.

In some implementations, the X-ray device can include a third shielding placed at one or more locations within the X-ray device. The third shielding can reduce X-ray backscatter from the detector from exiting an infeed or an outfeed of the X-ray device.

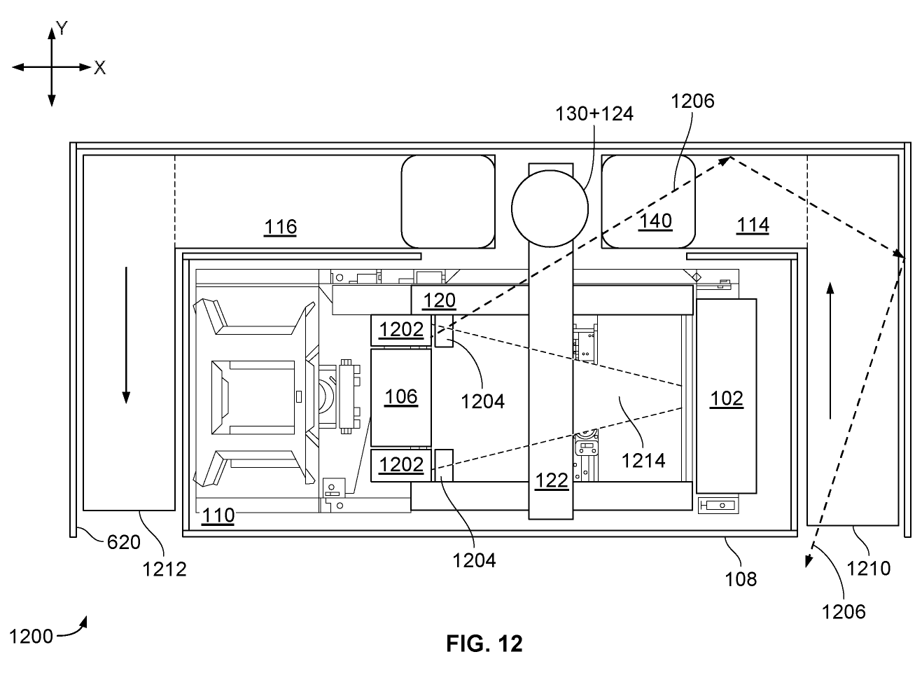

FIG. 12 shows an example of an X-ray device 1200 having a third shielding 1204.

As described herein, the primary shielding 108 and the secondary shielding 620 form a tunnel having bends to attenuate X-rays that leave the scan chamber through the opening into the tunnel. However, in some implementations, even with the primary shielding 108 and the secondary shielding 620, X-rays can still exit from an infeed 1210 or an outfeed 1212 of the X-ray device 1200. In some implementations, the X-rays that exit from an infeed or an outfeed of the X-ray device can exceed a safety limit.

For example, to improve scan throughput, the X-ray source 102 can be configured to operate at an increased power, e.g., at 150W (200kV and 750μA) rather than 95W. Without the third shielding 1204, the X-rays at the infeed 1210 of the X-ray device 1200 may exceed the 1.0 μSv/hr safety limit at a 5cm distance from the infeed 1210.

One source of the X-rays that exit from an infeed or an outfeed of an X-ray device can be X-ray backscatter from the detector 106. When photons of the X-ray interact with matter, some of the photons can reflect backward, resulting in X-ray backscatter. For example, when the X-rays interact with one or more components of the detector 106, some of the X-rays, e.g., the X-rays 1206, can reflect backward. The backscattered X-rays 1206 can propagate along the tunnel, e.g., with too few bounces to sufficiently reduce the backscattered X-rays, and exit the X-ray device. For example, the X-ray backscatter may exit an infeed 1210 of the X-ray device 1200.

In order to reduce X-ray backscatter from the detector 106 from exiting an infeed or an outfeed of the X-ray device 1200, in some implementations, the X-ray device 1200 can include a third shielding placed at one or more locations within the X-ray device. In some implementations, the one or more locations where the third shielding is placed can include locations inside the scan chamber between the X-ray source and two sides of a mounting structure for the detector.

The detector 106 can include a detector assembly. The detector 106 can include a scintillator, a camera, a mirror, a sheet metal detector, a lead blast wall, or any other suitable components in an X-ray detector. The detector assembly can include a mounting structure for the detector. For example, the X-ray device 1200 can include a mounting structure 1202 for the detector 106. In some implementations, the mounting structure 1202 can include a mounting frame that fixes one or more components of the detector assembly to a predetermined location within the X-ray device. The mounting frame can use a metal material, e.g., aluminum.

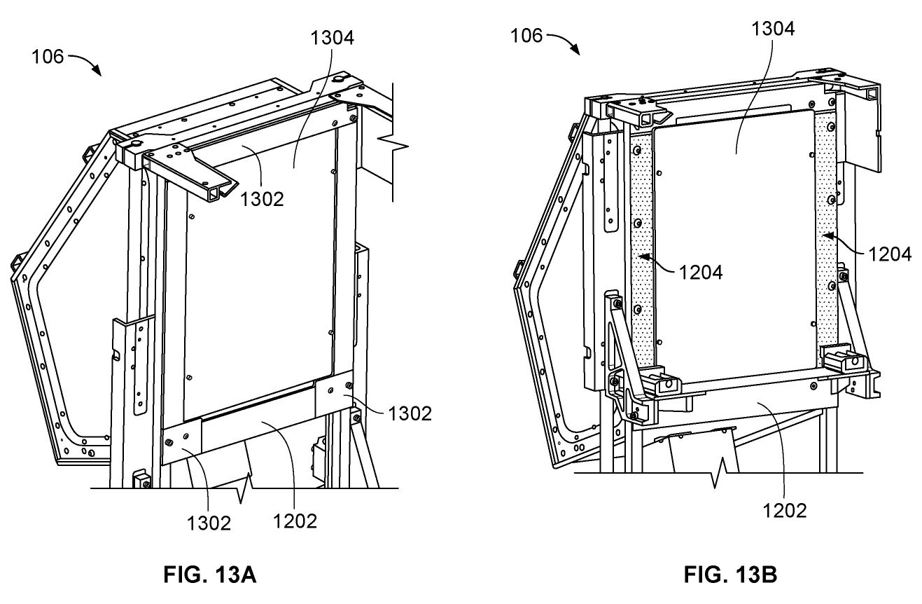

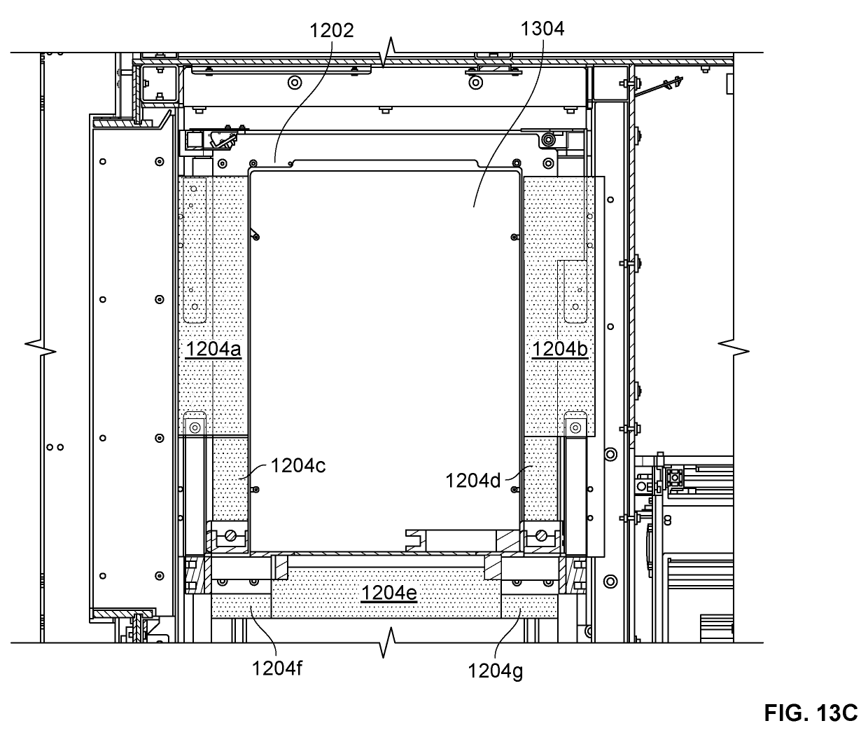

FIG. 13A shows an example of a detector 106 having a mounting structure 1202. The mounting structure 1202 can include a mounting frame having a top side, a bottom side, a left side, and a right side. The detector 106 can include a scintillator 1304. The mounting structure 1202 can fix the scintillator 1304 to a predetermined location within the X-ray device 1200. For example, the mounting structure 1202 can include one or more structural parts 1302 that hold the scintillator 1304 in place using fasteners. Two fasteners located on the top side of the mounting structure 1202 and two fasteners located at the bottom side of the mounting structure 1202 can physically support the detector 106.

One source of the X-ray backscatter can be X-rays that are reflected from the mounting structure 1202. For example, referring to FIG. 12, the mounting structure 1202, e.g., an aluminum mounting structure, surrounding the detector 106 can be a source of scattered and emitted photons.

The X-ray device 1200 can include a third shielding 1204. The third shielding 1204 can be placed at locations inside the scan chamber 110 between the X-ray source 102 and two sides of the mounting structure 1202 for the detector 106. For example, two shieldings 1204 can be positioned at the left side and the right side of the mounting structure 1202. The shieldings 1204 can reduce the amount of the backscattered X-rays, e.g., the X-ray 1206, emitting from the mounting structure 1202. Thus, the amount of X-ray backscatter exiting an infeed 1210 or an outfeed 1212 of the X-ray device 1200 can be reduced, and can satisfy the safety limit. FIG. 13B shows an example of a third shielding 1204 placed on two sides of a mounting structure 1202 for a detector 106. For example, a lead shielding can be placed on the left side and the right side of the mounting structure 1202 that supports the scintillator 1304.

FIG. 13C shows an example of a third shielding 1204 placed on three sides of a mounting structure 1202 for a detector 106. The third shielding 1204 can include two or more lead side panels. The third shielding 1204 can include one or more shieldings 1204a and 1204c placed on the left side of the mounting structure 1202, one or more shieldings 1204b and 1204d placed on the right side of the mounting structure 1202, and one or more shieldings 1204e, 1204f, and 1204g on the bottom side of the mounting structure 1202, to reduce backscatter. In some implementations, the one or more shieldings placed at the bottom side of the mounting structure 1202 can leave an opening to allow airflow. In some implementations, the third shielding can be placed at the top side of the mounting structure 1202 (not shown in FIG. 13C), e.g., with modification to a design of the top side of the mounting structure that provides physical support for the detector 106. For example, the aluminum mount plate can be modified with additional threaded holes because the existing plate may not have mounting features for the lead panels.

In some implementations, a material for the third shielding 1204 can include a high atomic number material, e.g., a high-Z shielding material. For example, the material for the third shielding can be lead, lead laminate, tungsten, or tungsten-filled Polyethylene Terephthalate Glycol (PETG) filament.

By placing the third shielding around the mounting structure of the detector, the backscattered X-rays can be intercepted and attenuated by the third shielding before the backscattered X-rays can reach the infeed or the outfeed of the X-ray device, and exit the X-ray device. This localized shielding solution can address the specific radiation path responsible for the elevated emissions, rather than requiring modifications to the tunnel geometry or modifications to the outer enclosure.

In some implementations, the third shielding can not only reduce X-ray backscatter from the detector, but can also improve the quality of radiograph and reconstruction images of the X-ray device. The third shielding can reduce the amount of X-ray backscatter received by the detector. The radiograph and the reconstruction images can have reduced scatter artifacts caused by the X-ray backscatter. Thus, the third shielding can improve the quality of the radiographs and the reconstruction images generated from using the X-ray device.

In some implementations, the third shielding can include a cover over the shielding material to protect the surface of the shielding material. For example, lead laminates using galvanized steel can be prone to scratching during handling and the laminating process. The third shielding can include a thin cosmetic cover over the lead laminate to protect the lead surface. For example, the third shielding 1204 can include lead side panels each with a sheet metal cover. In some implementations, powder coating can be applied over the shielding material to protect the surface of the shielding material.

In some implementations, the one or more locations where the third shielding is placed can include the opening 112 into the scan chamber 110. For example, the third shielding can include a shielding curtain made of a shielding material, e.g., lead. The third shielding can be lifted from the opening 112, e.g., by the motion of a scan object, when the scan object enters or exits the scan chamber 110 through the opening 112. For example, a pallet can be firmly secured when a scan object passes through the shielding curtain. The third shielding can reduce the X-ray backscatter from exiting the opening 112 when the scan object is being scanned by the X-ray device. In some implementations, the opening 112 can include two or more portions, e.g., a top portion and a bottom portion. The third shielding can include a shielding curtain that covers only one portion, e.g., the top portion or the bottom portion of the opening.

In some implementations, the one or more locations where the third shielding is placed can include a location on one side (e.g., the side closer to the opening 112) of the X-ray source. For example, the third shielding can be placed immediately from a side, e.g., the right side, of the X-ray source 102 (e.g., the side closer to the opening 112) to reduce the X-ray backscatter. In some implementations, the third shielding can be immediately adjacent to the X-ray source. In some implementations, the third shielding can be placed at a location between the X-ray source and the internal wall of the primary shielding. The third shielding is placed at a location so that the third shielding does not interfere with the scanning envelope and will not result in a part collision during part handling and scanning. The shielding can cut off a scatter path and can reduce X-ray backscatter from exiting an infeed or an outfeed of the X-ray device.

In some implementations, the one or more locations where the third shielding is placed can include a location outside the scan chamber and within the X-ray device. In some implementations, the one or more locations where the third shielding is placed can include a location inside the tunnel formed by the primary shielding and the secondary shielding. For example, the third shielding can include a lead barrier to reduce scatter through the tunnel and thus X-rays exiting an infeed or an outfeed of the X-ray device. In some implementations, the third shielding can be placed on the top panel of the tunnel, at one or more corners of the tunnel, at a bottom panel of the tunnel, or any combination of these. In some implementations, the third shielding can include a semi-baffle barrier. A semi-baffle barrier can block some of the scattered emissions at all times or can block all of the emissions at some times. For the former case, semi-baffle barriers can include partial walls or apertures along the length of the tunnel to increase the average path length or reduce the ratio of tunnel width to length while still permitting parts to transit through the machine. For the latter, curtains made of lead or other shielding materials can be used to block emissions when parts are not transiting through and can be pushed out of the way when parts need to get through. Multiple layers of curtains can increase the shielding amount when parts are transiting through the curtains.

In some implementations, the third shielding can include a combination of the various techniques described herein, such as a shielding inside the scan chamber between the X-ray source and two sides of a mounting structure for the detector, a shielding curtain at the opening of the scan chamber, a shielding immediately next to the X-ray source, or one or more locations inside the tunnel.

In some implementations, the X-ray device can use other non-shielding techniques to reduce backscatter, alone or in combination with the third shielding described herein. In some implementations, the X-ray device can include an X-ray collimator that provides collimation at the X-ray source. In some implementations, the collimation can complement the third shielding that is adjacent to the detector to further reduce X-ray backscatter. For example, the X-ray device 1200 can include collimation at the X-ray source 102 to reduce the width/radius of the X-ray fan/ X-ray cone 1214. This collimation can reduce the amount of X-rays that interact with the mounting structure 1202, generate backscatter, and do not contribute to X-ray imaging.

In some implementations, the length of the tunnel can be larger than a predetermined value. The X-ray device can include one or more removable tunnel extensions that increase the length of the infeed tunnel or the length of the outfeed tunnel, or both. By increasing the length of the tunnel, the X-ray backscatter can get a few more bounces inside the tunnel, reducing the amount of the X-ray backscatter that exits the infeed or the outfeed of the X-ray device.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. An X-ray device comprising:
an X-ray source configured to emit X-rays;
a detector configured and arranged to obtain X-ray scan data for objects;
a primary shielding forming a scan chamber, wherein the X-ray source and the detector are located inside the scan chamber, and the scan chamber has an opening into the scan chamber;
a secondary shielding outside of the primary shielding and forming with the primary shielding a tunnel having bends to attenuate any X-rays that leave the scan chamber through the opening into the tunnel; and
a conveyor system configured and arranged to move the objects through the tunnel to the scan chamber.

2. The X-ray device of claim 1, wherein the primary shielding and the secondary shielding form a double wall of shielding across an emission path of the X-ray source, and optionally, a ratio of a maximum width of the tunnel to a length of the tunnel has been minimized for a predefined maximum size of the objects in view of energy, flux, and/or beam geometry of the X-ray source and, optionally a predefined maximum size of the X-ray device.

3. The X-ray device of claim 1, wherein each of the bends is a ninety degree bend in the tunnel.

4. The X-ray device of claim 1, comprising a motion system located at least partially inside the scan chamber, the motion system being configured and arranged to move the objects from the conveyor system, through the opening, and into the scan chamber.

5. The X-ray device of claim 4, wherein the tunnel has a first portion and a second portion, the first portion of the tunnel has at least one of the bends, the second portion of the tunnel has at least one of the bends, the conveyor system has a first portion and a second portion, the first portion of the conveyor system is configured and arranged to move the objects from an infeed of the X-ray device through the first portion of the tunnel to the scan chamber, the second portion of the conveyor system is configured and arranged to move the objects away from the scan chamber through the second portion of the tunnel, and the motion system is configured and arranged to move the objects both (i) from the first portion of the conveyor system into the scan chamber and (ii) from the scan chamber to the second portion of the conveyor system.

6. The X-ray device of claim 5, wherein the first and second portions of the conveyor system comprise a single pick-up and drop-off location for the objects by the motion system.

7. The X-ray device of claim 5, wherein the first portion of the conveyor system comprises a pick-up location for the objects by the motion system, and the second portion of the conveyor system comprises a drop-off location for the objects by the motion system, the drop-off location being separated from the pick-up location.

8. The X-ray device of claim 5, comprising a ramp to an outfeed of the X-ray device, wherein the ramp is located inside the second portion of the tunnel, and the second portion of the conveyor system is configured and arranged to move the objects away from the scan chamber and to a beginning of the ramp.

9. The X-ray device of claim 1, wherein a first portion of the tunnel has two bends between an infeed of the X-ray device and the scan chamber, and a second portion of the tunnel has two bends between the scan chamber and an outfeed of the X-ray device.

10. The X-ray device of claim 1, wherein each of the objects comprises a component removably attached to a carriage.

11. The X-ray device of claim 10, comprising a motion system located at least partially inside the scan chamber, the motion system being configured and arranged to move the objects from the conveyor system, through the opening, and into the scan chamber, wherein
the conveyor system is a split-belt conveyor system,
the motion system is a three-axis gantry comprising a rotary stage and an axis of motion that extends through the opening in the scan chamber and below a plane of the split-belt conveyor system,
the rotary stage is configured to hold and rotate the carriage within a scan envelope of the X-ray source inside the scan chamber with the component removably attached thereto,
the rotary stage comprises gripper configured to grasp, hold and release the carriage, and
the three-axis gantry is configured to (i) lift the carriage off the conveyor system after the gripper has grasped the carriage, (ii) move the carriage into the scan envelope for rotation by the rotary stage during a scan, (iii) move the carriage out of the scan envelope and back to the conveyor system after the scan, and (iv) place the carriage back on the conveyor system.

12. The X-ray device of claim 10, wherein the component comprises a manufactured part in a fixturing device, and the carriage includes fastener points that are configured and arranged to receive fasteners of the fixturing device.

13. The X-ray device of claim 1, wherein the conveyor system is a split-belt conveyor system consisting of two, three, four, five, six, seven or eight conveyor belts.

14. The X-ray device of claim 1, comprising a third shielding placed at one or more locations within the X-ray device that reduces X-ray backscatter from the detector from exiting an infeed or an outfeed of the X-ray device.

15. The X-ray device of claim 14, wherein the one or more locations comprise locations inside the scan chamber between the X-ray source and two sides of a mounting structure for the detector.

16. The X-ray device of claim 1, wherein the primary shielding and the secondary shielding form a double wall of shielding across an emission path of the X-ray source, and a ratio of a maximum width of the tunnel to a length of the tunnel has been minimized for a predefined maximum size of the objects in view of energy, flux, and/or beam geometry of the X-ray source, and
wherein the X-ray device comprises a motion system located at least partially inside the scan chamber, the motion system being configured and arranged to move the objects from the conveyor system, through the opening, and into the scan chamber.

17. The X-ray device of claim 16, wherein the tunnel has a first portion and a second portion, the first portion of the tunnel has at least one of the bends, the second portion of the tunnel has at least one of the bends, the conveyor system has a first portion and a second portion, the first portion of the conveyor system is configured and arranged to move the objects from an infeed of the X-ray device through the first portion of the tunnel to the scan chamber, the second portion of the conveyor system is configured and arranged to move the objects away from the scan chamber through the second portion of the tunnel, and the motion system is configured and arranged to move the objects both (i) from the first portion of the conveyor system into the scan chamber and (ii) from the scan chamber to the second portion of the conveyor system.

18. The X-ray device of claim 17, wherein the first and second portions of the conveyor system comprise a single pick-up and drop-off location for the objects by the motion system, and
wherein the X-ray device comprises a ramp to an outfeed of the X-ray device, wherein the ramp is located inside the second portion of the tunnel, and the second portion of the conveyor system is configured and arranged to move the objects away from the scan chamber and to a beginning of the ramp.

19. The X-ray device of claim 17, wherein the first portion of the conveyor system comprises a pick-up location for the objects by the motion system, and the second portion of the conveyor system comprises a drop-off location for the objects by the motion system, the drop-off location being separated from the pick-up location, and
wherein the X-ray device comprises a ramp to an outfeed of the X-ray device, wherein the ramp is located inside the second portion of the tunnel, and the second portion of the conveyor system is configured and arranged to move the objects away from the scan chamber and to a beginning of the ramp.

20. The X-ray device of claim 1, wherein the primary shielding and the secondary shielding form a double wall of shielding across an emission path of the X-ray source, a ratio of a maximum width of the tunnel to a length of the tunnel has been minimized for a predefined maximum size of the objects in view of energy, flux, and/or beam geometry of the X-ray source and for a predefined maximum size of the X-ray device, and
wherein a first portion of the tunnel has two bends between an infeed of the X-ray device and the scan chamber, and a second portion of the tunnel has two bends between the scan chamber and an outfeed of the X-ray device.
